(19) United States
(12) Patent Application Publication
(10) Pub. No.: US 2002/0038485 A1
(43) Pub. Date: Apr. 4, 2002

(54) Electronic toothbrush and electronic brush

(76) Inventors: Yoshinori Nakagawa, Nara-ken (JP); Takahiro Ikejiri, Osaka (JP)

Correspondence Address: FULBRIGHT & JAWORSKI, LLP, 666 FIFTH AVE, NEW YORK, NY, 10103-3198, US

(21) Appl. No.: 09/738,007

(22) Filed: Dec. 15, 2000

(30) Foreign Application Priority Data
Jul. 17, 2000 (JP) 2000-215332

(51) Int. Cl. A46B 9/04; A61C 17/00; A47L 11/00; A47L 21/02

(52) U.S. Cl. 15/28; 15/105; 15/167.1

(57) ABSTRACT

An electronic toothbrush comprising: a brush head portion having a bristle portion, to be inserted into an oral cavity, for washing teeth; and a holder portion to be exposed outside the oral cavity, an n-type semiconductor is provided so as to be capable of receiving external light; and a battery is provided so as to be capable of superposing an electric potential on the n-type semiconductor.

### BACKGROUND OF THE INVENTION

1. Field of the Invention

The present invention relates to an electronic toothbrush and an electronic brush, and more specifically to an electronic toothbrush and an electronic brush using a photocatalytic reaction of an n-type semiconductor.

2. Description of the Related Art

As a method for preventing intraoral diseases such as dental caries or alveolar pyorrhea, application of a fluoride on the tooth surface or use of a dentifrice containing a fluoride has been conventionally practiced in order to further improve the prevention effect than simply brushing the tooth surface with a toothbrush bearing a dentifrice adhered thereon However, questions remains as to the effect of these methods because an fluorine ion is inferior in permeability with respect to pulp tissue, and hence, in order to improve the effect of the fluorine ion, a method has been suggested that permeability of a fluorine ion is improved by increasing an electric potential by the action of an external power supply such as battery, domestic power supply and the like.

However, also this method is not desirable because it has a problem that metal ions associated with generation of an electric current will flow out because a metal which is a conductor is used for the toothbrush portion, and in addition, the electric current, electromagnetic waves, electric fields can have detrimental effects on a human body when used for a long time.

In view of the above, the inventors of the present invention invented an electronic toothbrush utilizing a photocatalytic reaction of TiO₂ which is an n-type semiconductor, which does not cause such a problem (Japanese Unexamined Patent Publication JP-A 58-41549 (SHO-58, 1983). TiO₂ is a compound that generates a photoelectron voltage even under the irradiation condition by relatively weak light, and when inserted into the oral cavity, generates OH radicals from the moisture such as saliva and elevates the pH in the oral cavity to accomplish neutralization, thereby decreasing the activity of etiologic bacteria of dental caries, as well as decomposing dental plaque.

However, in the case where only the photocatalytic reaction of TiO₂ is used, the method of decreasing the activity of etiologic bacteria of dental caries having high activity in an acidic atmosphere will accomplish a predetermined effect as it is, however it inevitably requires a certain time before it exerts the effect. In other words, the direct reason of generation of dental caries is that lactic acid which is generated at the time when the etiologic bacteria of dental caries ferment saburra attacks hard tissue of a tooth, and there is a problem that the lactic acid is continuously generated until the activity of the etiologic bacteria of dental caries is decreased.

The inventors of the present invention made a thorough study for enabling effective decomposition of generated lactic acid, and found that effective decomposition of lactic acid can be accomplished by providing an electric potential of more than or equal to a predetermined value at the time of using the photocatalytic reaction of the n-type semiconductor, and that such an effect acts not only on decomposition of the lactic acid but also on decomposition of organic matters.

### SUMMARY OF THE INVENTION

In view of the above problems, it is an object of the invention to provide an electronic toothbrush which, by using a photocatalytic reaction of the n-type semiconductor, not only decreases the activity of etiologic bacteria of dental caries but also improves decomposition of generated lactic acid, thereby preventing dental caries more effectively, and to provide an electronic brush which can wash each part of a body more effectively than the case where washing is conducted simply by using soap water, by decomposing organic waste such as dirt generated at each part of the body.

The aforementioned object is accomplished by the invention according to each claim. That is, an electronic toothbrush according to the present invention is featured by comprising a brush head portion having a bristle portion, to be inserted into an oral cavity, for brushing teeth and a holder portion to be exposed to the outside the oral cavity, and being provided with an n-type semiconductor capable of receiving external light, and a battery capable of superposing an electric potential to the n-type semiconductor.

According to the present configuration, owing to the photocatalytic action of the n-type semiconductor, in the case where the toothbrush is inserted into an oral cavity, in addition that OH radicals generated by decomposition of moisture such as saliva increase the pH within the oral cavity to neutralize the same, thereby decreasing the activity of etiologic bacteria of dental caries, the OH radicals reliably and rapidly decompose lactic acid generated by lactic fermentation of foods by bacteria, so that it is possible to prevent dental caries from occurring. In other words, in contrast to the case where only the photocatalytic action of n-type semiconductor effected by external light is employed (e.g. fluorescent lamp in a washroom), by superposing the electric potential of the battery, it is possible to achieve an energy level required for decomposing lactic acid and water, so that the photocatalytic efficiency of the n-type semiconductor can be improved synergistically. As a consequence, it is possible to improve the efficiency of generation of OH radical while reliably improving the pH by tooth brushing operation. Additionally, in the case of practically performing tooth brushing operation in a washroom and the like, even under the condition that light irradiation is weak because illumination of lighting equipment such as fluorescent lump in the washroom is low, since the battery which makes the electric potential of the n-type semiconductor more than or equal to a predetermined value is provided, it is possible to stably achieve a desired effect. As a result, according to the present invention, it is possible to provide an electronic toothbrush that can prevent intraoral diseases such as dental caries more effectively.

It is preferable that the n-type semiconductor is TiO₂, and that output of the battery is more than 0.5 V and less than 3.0 V.

According to the present configuration, TiO₂ is effective for improving decomposition of lactic acid or the pH because it exhibits particularly large photocatalytic efficiency among n-type semiconductors, and use of TiO₂ is advantageous because the electric potential required for causing a photocatalytic action is maintained more than or equal to the predetermined value, as well as the current flowing into a human body via the hand is kept especially weak to arise no adverse effect on the human body. In other words, if the output of the battery is less than or equal to 0.5V, decomposition of lactic acid is insufficient, whereas if the output of the battery is more than or equal to 3.0 V, decomposition of lactic acid is promoted, however, the current flowing into a human body is increased to cause discomfort, and thus such ranges are not preferable.

In the case where TiO₂ is used as the n-type semiconductor, the reaction formula for decomposing lactic acid into water and carbon dioxide by photocatalytic action is as follows:

hν

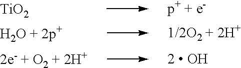

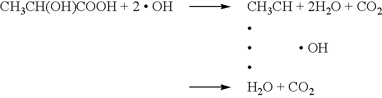

wherein “p⁺” represents a positive hole, “e⁻” represents an electron and “.OH” represents an OH radical.

It is preferable that the battery is either one of a primary battery, a secondary battery and a solar battery, or combination thereof.

The present configuration is advantageous because it is possible to readily secure the battery output of more than 0.5 V and less than 3.0 V while realizing durability and low cost. As the primary battery, an alkaline battery, a sliver oxide battery, an air/zinc battery and the like can be used, while as the secondary battery, a nickel/hydrogen battery, a lithium battery and the like can be used.

It is preferable that the TiO₂ is an anatase-type crystal.

The present configuration is advantageous because such a type of TiO₂ has particularly large photocatalytic efficiency among other types of TiO₂. In this context, an anatase-type crystal can be easily obtained, for example, by the method of heating pure Ti to 1200 to 1500° C. for several minutes in an oxidizing atmosphere.

Furthermore, an electronic brush according to the present invention is featured by comprising a brush head portion having a bristle portion, and being provided with an n-type semiconductor capable of receiving external light, and a battery capable of superposing an electric potential to the n-type semiconductor.

According to the present configuration, owing to the photocatalytic action of the n-type semiconductor, in the case of washing each part of a body using soap water and the like, OH radicals generated by decomposition of moisture reliably and rapidly decompose organic waste such as dirt on the skin surface, so that higher washing effect is achieved compared to the case where only the soap water is used. In other words, in contrast to the case where the photocatalytic action of the n-type semiconductor is caused by only the external light (e.g. fluorescent lamp in a bathroom or washroom), by superposing the electric potential of the battery, it is possible to achieve an energy level required for decomposing organic waste on the skin surface and water, so that photocatalytic efficiency of the n-type semiconductor can be improved synergistically. As a consequence, it is possible to improve the efficiency of generation of OH radical by scrubbing operation of skin surface. Additionally, in the case of practically performing washing operation in a bathroom and the like, even under the condition that light irradiation is weak because illumination of lighting equipment is low, and even if the lighting equipment is an incandescent lamp rather than a fluorescent lamp, since the battery which makes the electric potential of the n-type semiconductor more than or equal to a predetermined value is provided, it is possible to stably achieve a desired effect. As a consequence, according to the present invention, it is possible to provide an electronic brush capable of washing each part of a body more effectively compared to the case where washing is performed with only soap water.

### BRIEF DESCRIPTION OF THE DRAWINGS

FIG. 1 is a schematic partial section view showing one embodiment of an electronic toothbrush according to the present invention;

FIG. 2 is a section view along the line II-II of FIG.

FIG. 3 is a graph showing time-varying decomposition of lactic acid by the electronic toothbrush according to the present invention;

FIG. 4 is a graph showing relationship of battery voltage with respect to decomposition of lactic acid by the electronic toothbrush according to the present invention; and

FIG. 5 is schematic partial section view showing one embodiment of an electronic brush according to the present invention.

### DETAILED DESCRIPTION OF THE PREFERRED EMBODIMENT

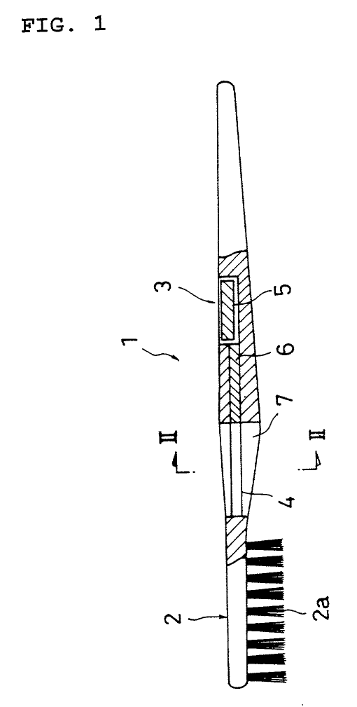

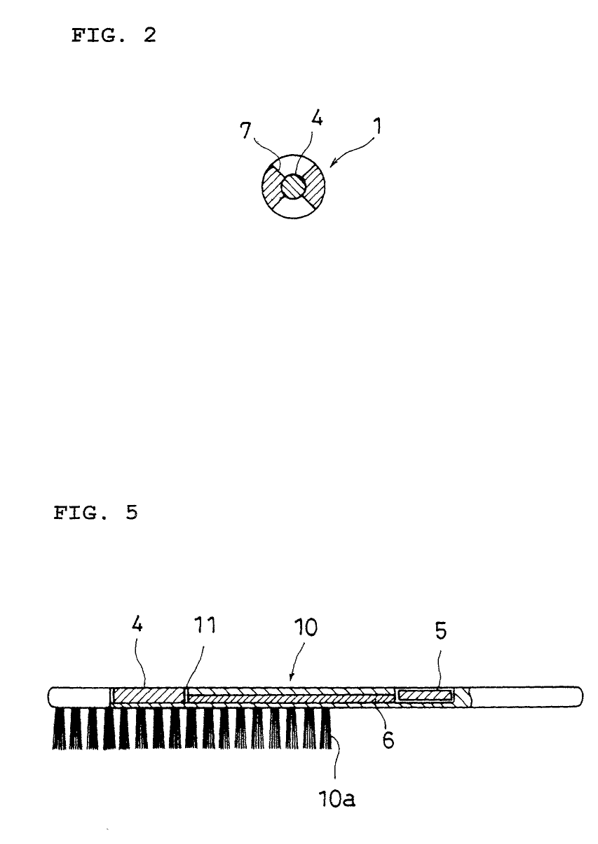

Embodiments of the present invention will be described in detail with reference to the drawings. FIG. 1 shows a schematic sectional structure of an electronic toothbrush according to the present embodiment (hereinafter, also referred to simply as “toothbrush”). This toothbrush 1 comprises a brush head portion 2 in which bristles 2a are implanted, and a holder portion 3 to be exposed outside an oral cavity. Preferably, these brush head portion 2 and the holder portion 3 can be separated from each other. In other words, when the head portion 2 having the bristles 2a to be consumed is designed to be replaceable as a consumable item in case of necessary, in addition to the economical advantage, an advantage of reducing the size of the waste compared to the case where the entire toothbrush is disposed are achieved.

In the holder portion 3, a TiO₂ rod 4 which is an n-type semiconductor, as well as an alkaline battery 5 of the button shape of 1.5 V are incorporated, and the battery 5 and the TiO₂ rod 4 are connected with each other via a conductive line 6 such as copper wire. At the interface between the brush head portion 2 and the holder portion 3, there is formed a groove 7 by reducing the section partly for ease of irradiation of the external light to then-type semiconductor. The battery 5 is replaceable as it is consumed.

The TiO₂ rod 4 is formed by heating a rod of pure Ti to 1200 to 1500° C. in an oxidizing atmosphere for several minutes to thereby form a TiO₂ layer on the surface thereof. TiO₂ of this case is anatase-type crystalline and thus possesses an especially large photocatalytic capability. And when the TiO₂ rod 4 receives the external light to give rise to a photocatalytic reaction, the battery 5 increases or maintains the electric potential of TiO₂ which is an n-type semiconductor.

### EXAMPLES

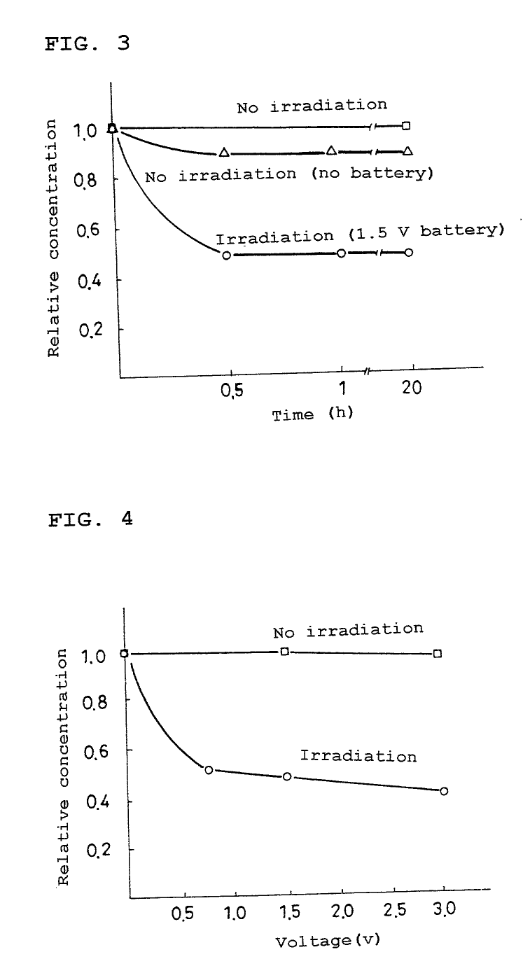

A plurality of vials in each of which 5 mL of 2 mM calcium lactate is introduced, and a Ti rod formed with a TiO₂ layer comprising an anatase-type crystal on the surface thereof is inserted were-prepared, and under irradiation of a fluorescent lump of 6 W, voltages were applied by means of the batteries of 0.75 V, 1.5 V and 3.0 V. Decomposition of lactic acid after lapse of time was measured by the capillary electrophoresis. The results are shown in FIGS. 3 and 4 as comparison among the case where irradiation by the fluorescent lump is conducted with a battery being attached, the case where irradiation by the fluorescent lump is conducted without use of a battery; and the case where irradiation is not conducted.

FIG. 3 is a graph showing results of the samples to which a battery voltage of 1.5 V was applied, and in this graph, the vertical axis shows amount of decrease of lactic acid in relative concentration, and the horizontal axis shows elapsed time. This graph shows that superposing effect is achieved by irradiation of the fluorescent lamp (about 50% of lactic acid was decomposed by the irradiation of 0.5 hour) To the contrary, it can be seen from the same graph that decomposing action of lactic acid is not sufficient for the configuration in which a battery is not used but only the n-type semiconductor is used.

Similarly, FIG. 4 is a graph showing influence of application of the voltage of the battery, and it can be seen that decomposition of lactic acid is observed at as early as 0.75 V.

(Other Embodiments of the Invention)

(1) In the above embodiment, an example of an electronic toothbrush using TiO₂ which is an n-type semiconductor has been shown, however, it is also possible to use TiO₂ which is an n-type semiconductor in an electronic brush 10 as shown in FIG. 5. More specifically, this electronic brush 10 is provided with bristles 10a implanted therein on the front side constituting a brush head portion, and is formed into a holder portion on the rear side, into which a button battery 5 is embedded. This button battery 5 is covered with a rid member (not shown) and embedded in liquid-tight manner. On the front side where the bristles 10a are implanted, TiO₂ similar to that shown in the above embodiment is attached, while a groove 11 which functions as a water passage is formed in the vicinity of the TiO₂, whereby communication of soap water and the like is enabled. This groove 11 is formed by a penetration hole toward base portions of the bristles 10a, and is configured so that by scrubbing a body with the bristles 10a, the TiO₂ and the surface of the body are brought into contact with each other via the moisture, thereby facilitating decomposition and removal of organic matters such as dirt existing on the surface by the photocatalytic action of the TiO₂, and also allowing decomposition of the removed organic matters. Incidentally, the TiO₂ and the battery are made conductive via the conductor 6 as shown in FIG. 1. As the n-type semiconductor, the battery and the conductor, those similar to those used in the above embodiment can be used.

As the shape of the present electronic brush, various shapes other than that shown in FIG. 5 can be employed as far as the electronic brush is formed into a shape which enables washing by scrubbing each part of the body with the bristles while the holder portion being held by a hand. Each part of the body to be washed is not particularly limited, and hence the present electronic brush can be used as a so-called body brush, heir brush, face brush and the like.

(2) In the above embodiment, an example in which TiO₂ which is an n-type semiconductor is formed on a Ti rod in layered shape by heating the Ti rod, however not being limited to the above configuration, the TiO₂ may be entirely formed by sintering TiO₂ powder so far as a TiO₂ layer is formed on the light receiving surface. Also the production method may be such that the TiO₂ layer is generated on the conductive surface of a pure Ti rod and the like by the CVD method, PVD method and the like, and that the TiO₂ layer is generated on the surface resulted from anodic oxidation of a pure Ti rod.

(3) For the electronic toothbrush according to the above embodiment, an example is shown such that the groove 7 is formed at the interface between the brush head portion 2 and the holder portion 3 so as to facilitate irradiation of the external light to TiO₂ which is an n-type semiconductor, however, the brush head portion and the holder portion of the toothbrush may be formed of a light-permeable material such as transparent or translucent acrylic resin, urethane resin, PET resin and the like, thereby providing a structure without the groove. In addition, when a biodegradable resin is used as a resin for forming the brush head portion 2, influence on the environment is diminished even if the brush head portion 2 is disposed as a consumable item, which is desirable.

What is claimed is:

1. An electronic toothbrush comprising:
a brush head portion having a bristle portion (2a), to be inserted into an oral cavity, for washing teeth; and
a holder portion to be exposed outside the oral cavity,
an n-type semiconductor is provided so as to be capable of receiving external light; and
a battery is provided so as to be capable of superposing an electric potential on the n-type semiconductor.

2. The electronic toothbrush according to claim 1, wherein the n-type semiconductor is TiO₂, and output of the battery is more than 0.5 V and less than 3.0 V.

3. The electronic toothbrush according to claim 1 or 2, wherein the battery is either one of a primary battery, a secondary battery and a solar battery, or combination thereof.

4. The electronic toothbrush according to claim 2 or 3, wherein the TiO₂ is an anatase-type crystal.

5. The electronic toothbrush according to any one of claims 2 to 5, wherein the TiO₂ is rod like and incorporated into the brush head portion, while the battery is button like, and these battery and the TiO₂ are made conductive via a conductive line incorporated into the brush head portion.

6. An electronic brush comprising:
a brush head portion having a bristle portion,
characterized in that:
an n-type semiconductor is provided so as to be capable of receiving external light; and
a battery is provided so as to be capable of superposing an electric potential on the n-type semiconductor.

7. The electronic brush according to claim 6, wherein the n-type semiconductor is TiO₂, and output of the battery is more than 0.5 V and less than 3.0 V.

8. The electronic brush according to claim 6 or 7, wherein the battery is either one of a primary battery, a secondary battery and a solar battery, or combination thereof.

9. The electronic brush according to claim 7 or 8, wherein the TiO₂ is an anatase-type crystal.

10. The electronic brush according to any one of claims 7 to 9, wherein the battery is embedded in the holder portion following the brush head portion, while the TiO₂ is attached in the vicinity of the brush head portion, and these battery and the TiO₂ are made conductive via a conductive line.
